(19) United States
(12) Patent Application Publication
(10) Pub. No.: US 2019/0025261 A1
(43) Pub. Date: Jan. 24, 2019

(54) METHOD OF CLEANING DETECTION CELL OF ELECTRON CAPTURE DETECTOR, ANALYSIS METHOD, DETECTION CELL OF ELECTRON CAPTURE DETECTOR, ELECTRON CAPTURE DETECTOR, AND ANALYTICAL DEVICE

(71) Applicant: SHIMADZU CORPORATION, Kyoto-shi (JP)

(72) Inventor: Shinji UCHIYAMA, Kyoto-shi (JP)

(73) Assignee: SHIMADZU CORPORATION, Kyoto-shi (JP)

(21) Appl. No.: 16/037,025

(22) Filed: Jul. 17, 2018

(30) Foreign Application Priority Data
Jul. 24, 2017 (JP) 2017-142652

(51) Int. Cl. G01N 30/26; G01N 30/62; B08B 5/00

(52) U.S. Cl. CPC G01N 30/26; G01N 2030/025; B08B 5/00; G01N 30/62

(57) ABSTRACT

A method of cleaning a detection cell of an electron capture detector in which the detection cell includes a radiation source that emits radiation, a sample gas introduction port through which a sample gas is introduced, and a collector electrode, includes: introducing a cleaning gas into the detection cell of the electron capture detector.

### INCORPORATION BY REFERENCE

The disclosure of the following priority application is herein incorporated by reference: Japanese Patent Application No. 2017-142652 filed Jul. 24, 2017

### BACKGROUND OF THE INVENTION

### 1. Field of the Invention

The present invention relates to a method of cleaning a detection cell of an electron capture detector, an analysis method, a detection cell of an electron capture detector, an electron capture detector, and an analytical device.

### 2. Description of Related Art

Gas chromatography uses an electron capture detector (ECD) to detect a compound having a high electron affinity and including an atom having a high electronegativity such as halogen. When such an electron capture detector is used, noise generation caused by a change in a detection cell leads to a reduction in accuracy of data to be obtained.

Examples of the change in the detection cell causing the noise generation include contamination of a collector electrode by a sample gas and oxidation inside the detection cell. Japanese Unexamined Patent Application Publication No. 2011-128171 describes an electron capture detector that reduces contamination of a collector electrode by attaching the collector electrode at a position out of an axial extension of a column inserted into a detection cell.

### SUMMARY OF THE INVENTION

In a case where noise has already generated in an electron capture detector, heating can reduce noise caused by contamination of the collector electrode. However, further measures are required for reducing noise caused by oxidation inside a detection cell, in addition to the replacement of the detection cell performed in a related art.

According to the 1st aspect of the present invention, a method of cleaning a detection cell of an electron capture detector, the detection cell comprising a radiation source that emits radiation, a sample gas introduction port through which a sample gas is introduced, and a collector electrode, comprises: introducing a cleaning gas into the detection cell of the electron capture detector.

According to the 2nd aspect of the present invention, in the method of cleaning a detection cell of an electron capture detector according to the 1st aspect, it is preferred that the cleaning gas is a gas having a reducing property.

According to the 3rd aspect of the present invention, in the method of cleaning a detection cell of an electron capture detector according to the 2nd aspect, it is preferred that the cleaning gas is hydrogen.

According to the 4th aspect of the present invention, in the method of cleaning a detection cell of an electron capture detector according to any one of the 1st through 3rd aspects, it is preferred that the cleaning gas is introduced into the detection cell that is heated to a temperature of 500° C. or less.

According to the 5th aspect of the present invention, in the method of cleaning a detection cell of an electron capture detector according to any one of the 1st through 4th aspects, it is preferred that oxidation of the detection cell is prevented by holding the cleaning gas in the detection cell or continuously introducing the cleaning gas into the detection cell.

According to the 6th aspect of the present invention, an analysis method of analyzing a sample with an analytical device comprising an electron capture detector, the electron capture detector comprising a detection cell comprising a radiation source that emits radiation, a sample gas introduction port through which a sample gas is introduced, a makeup gas introduction port through which a makeup gas is introduced, and a collector electrode, comprises: performing a measurement of a change in an electrical response of a circuit comprising the collector electrode, the change being caused by introducing the sample gas through the sample gas introduction port and introducing the makeup gas through the makeup gas introduction port so that components of the sample receive electrons generated by the radiation; and, when the measurement is not performed, cleaning the detection cell by the method of cleaning a detection cell of an electron capture detector according to any one of the 1st through 5th aspects.

According to the 7th aspect of the present invention, a detection cell of an electron capture detector comprises a radiation source that emits radiation, a sample gas introduction port through which a sample gas is introduced, a collector electrode, and a cleaning gas introduction port through which a cleaning gas is introduced.

According to the 8th aspect of the present invention, in the detection cell of an electron capture detector according to the 7th aspect, it is preferred that the detection cell further comprises a makeup gas introduction port through which a makeup gas is introduced, the makeup gas introduction port being different from the cleaning gas introduction port.

According to the 9th aspect of the present invention, in the detection cell of an electron capture detector according to the 7th aspect, it is preferred that the detection cell further comprises a switching mechanism for switching between a makeup gas and the cleaning gas to be introduced through the cleaning gas introduction port.

According to the 10th aspect of the present invention, an electron capture detector comprises the detection cell of an electron capture detector according to any one of the 7th through 9th aspects.

According to the 11th aspect of the present invention, in the electron capture detector according to the 10th aspect, it is preferred that the electron capture detector further comprises a leakage detection sensor that detects leakage of the cleaning gas.

According to the 12th aspect of the present invention, an analytical device comprises the electron capture detector according to the 10th or 11th aspect.

### BRIEF DESCRIPTION OF THE DRAWINGS

FIG. 1 is a view showing a schematic configuration of an analytical device related to a method of cleaning a detection cell of an electron capture detector in an embodiment of the present invention.

FIG. 2 is a flowchart showing a flow of an analysis method including the method of cleaning a detection cell of an electron capture detector in the embodiment.

FIG. 3 is a view showing a schematic configuration of an electron capture detector in a variation.

FIGS. 4A and 4B are chromatograms obtained in an example: FIG. 4A shows a detected chromatogram and FIG. 4B shows a chromatogram normalized with respect to an area of a reference peak.

### DESCRIPTION OF EMBODIMENTS

Hereinafter, an embodiment for carrying out the present invention will be described with reference to the drawings. A method of cleaning a detection cell of an electron capture detector in the embodiment reduces noise in the electron capture detector by introducing a cleaning gas into the detection cell of the electron capture detector.

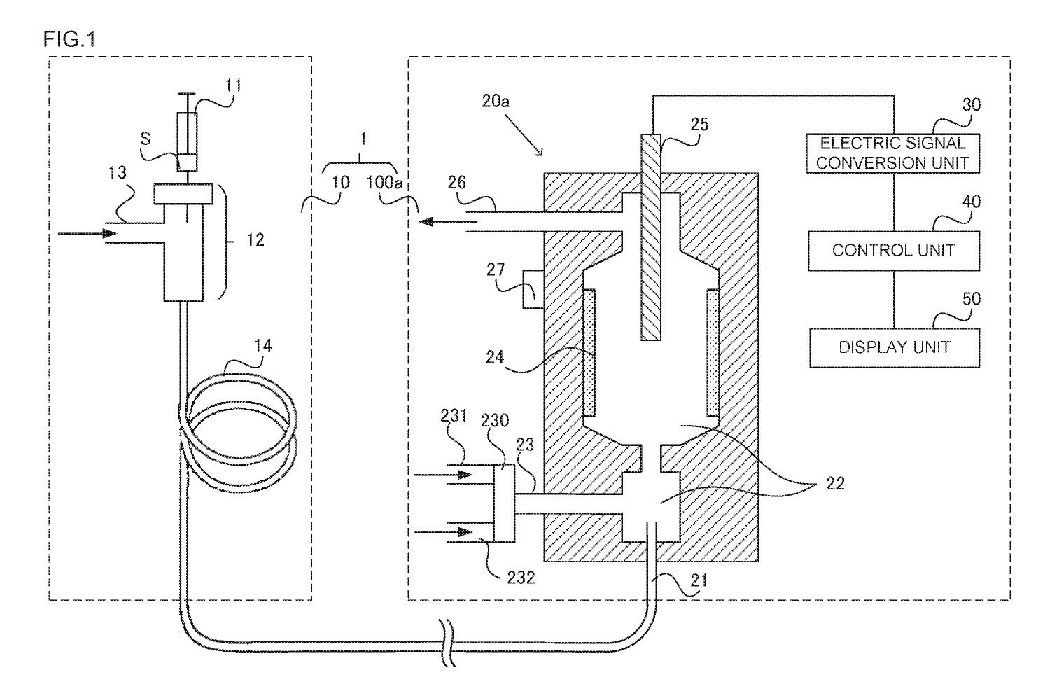

FIG. 1 is a view showing a schematic configuration of an analytical device (analyzer) 1 related to the method of cleaning a detection cell of an electron capture detector in the embodiment. The analytical device 1 is a gas chromatograph including a separation unit (separator) 10 and an electron capture detector 100a. The separation unit 10 includes a sample introduction unit 11, a sample vaporization unit 12, a carrier gas introduction port 13, and a separation column 14. The electron capture detector 100a includes a detection cell 20a, an electric signal conversion unit 30, a control unit 40, and a display unit 50. The detection cell 20a includes a sample gas introduction port 21, a cell chamber 22, a switching introduction port 23, a switching unit 230, a makeup gas flow path 231, a cleaning gas flow path 232, a radiation source 24, a collector electrode 25, a discharge port 26, and a gas leak sensor 27.

Note that some or all of functions of the control unit 40 and the display unit 50 are arranged in a remote electronic computer or the like so that the whole system shown in FIG. 1 can constitute an analyzing system.

The separation unit 10 separates components contained in a sample S based on their physical or chemical characteristics. The sample introduction unit 11 includes an injector, such as syringe or autosampler, to introduce the sample S held in the injector into the sample vaporization unit 12. The sample vaporization unit 12 includes a sample vaporization chamber to vaporize the introduced sample S. The carrier gas introduction port 13 includes an introduction port through which a carrier gas containing an inert gas such as nitrogen are introduced into the sample vaporization unit 12. The separation column 14 includes a column such as packed column or hollow capillary column. Components of the vaporized sample S (hereinafter referred to as sample gas S) are separated based on a partition coefficient between a mobile phase including the carrier gas and a stationary phase of the separation column 14 and other factors. The components, which have been separated from each other, are introduced through the sample gas introduction port 21 of the detection cell 20a at different points in time.

The detection cell 20a detects a compound having a high electron affinity contained in the sample S as a change in an electrical response of a circuit including the collector electrode 25. The sample gas introduction port 21 is an introduction port through which the sample gas S is introduced into the cell chamber 22 of the detection cell 20a. The cell chamber 22 includes a radiation source 24 fixed to the inner wall. The carrier gas, the makeup gas including an inert gas such as nitrogen, the sample gas, and a cleaning gas (described later) are introduced into the cell chamber 22. The switching introduction port 23 is an introduction port through which the carrier gas and the cleaning gas are introduced in a manner that they are switched to each other.

The switching unit 230 of the detection cell 20a includes a switching mechanism such as switching valve so that the switching unit 230 is configured to be switchable between first and second states described below. The first state allows the makeup gas, which passes through the makeup gas flow path 231, to flow through the switching introduction port 23 while it does not allow the cleaning gas, which passes through the cleaning gas flow path 232, to flow through the switching introduction port 23. The second state allows the cleaning gas to flow through the switching introduction port 23 while it does not allow the makeup gas to flow through the switching introduction port 23. The cleaning gas includes hydrogen. Hydrogen has a reducing property and therefore can reduce a degree of oxidation of the cell chamber 22. Thus, hydrogen acts as a cleaning gas.

Note that the composition of the cleaning gas is not particularly limited as long as the gas has a reducing property and does not adversely affect the measurement.

As described above, either one of the makeup gas and the cleaning gas can be selectively introduced into the detection cell 20a with the switching unit 230. When detection of the sample gas or the like are not performed in the electron capture detector 100a, the cleaning gas is introduced into the cell chamber 22 of the detection cell 20a to reduce oxidation of the cell chamber 22, which can result in a reduction of noise in the electron capture detector 100a.

Switching between the makeup gas and the cleaning gas to be introduced into the detection cell 200a may be performed by replacing a storage container of the makeup gas with a storage container of the cleaning gas or vice versa. In this way, the method of cleaning a detection cell of an electron capture detector in the embodiment can be applied without changing the design of the detection cell 200a.

The radiation source 24 includes a beta ray radiator that emits beta rays such as ⁶³Ni. The radiation source 24 ionizes nitrogen or the like introduced as the makeup gas or the carrier gas to generate electrons. A voltage V that is higher than a voltage on the inner wall of the cell chamber 22 is applied to the collector electrode 25 under the control of the electronic signal conversion unit 30, so that the collector electrode 25 collects electrons generated by the beta ray from the radiation source 24 and ions generated by exchange of these electrons. The collector electrode 25 extends, in a height direction (the vertical direction in the drawing), from a surface of the cell chamber 22 located opposite to a side on which the sample gas introduction port 21 is disposed. Additionally, a part of the collector electrode 25 faces the radiation source 24.

During the measurement, the switching unit 230 is in the first state; thus, it allows the makeup gas to flow into the detection cell 20a while it does not allow the cleaning gas to flow into the detection cell 20a. In a space inside the cell chamber 22, an inert gas such as nitrogen is ionized by the beta ray from the radiation source 24 to generate electrons. The generated electrons are attracted to the collector electrode 25, to which the voltage V is applied with respect to the inner wall of the cell chamber 22. The electrons are thus observed as a current passing through the collector electrode 25. In the embodiment, a pulse-shaped voltage (hereinafter referred to as a pulse voltage) is applied to the collector electrode 25.

Among the components of the sample gas S, a compound containing an atom having a high electronegativity such as halogen has a high electron affinity. Accordingly, the compound accepts the electrons generated inside the cell chamber 22 as described above to become an anion. The generated anion has a much large mass and moves slowly compared with an electron. Thus, given the same number of anions and electrons, the number of anions that reach the collector electrode 25 per unit time is smaller than that in a case with electrons. Therefore, the current flowing through the collector electrode 25 changes when the compound having a high electron affinity as described above is contained in the sample gas S.

The carrier gas, the makeup gas, the sample gas, and the cleaning gas introduced into the cell chamber 22 are discharged from the discharge port 26. The gas leak sensor 27 is disposed outside the detection cell 20a to measure a concentration of hydrogen, which is highly inflammable, contained in the cleaning gas. When the concentration reaches a predetermined level or more, the gas leak sensor 27 issues a warning sound or the like.

The electric signal conversion unit (electric signal converter) 30 includes an integrating circuit, an analog/digital converter (A/D converter), a voltage/frequency converter (V/F converter), and the like to appropriately convert an electric signal from the collector electrode 25 and to output the electric signal to the control unit 40. The electric signal conversion unit 30 converts a current passing through the collector electrode 25 into a voltage by the integrating circuit. Based on a level of the voltage, the V/F converter controls the frequency of the pulse voltage applied to the collector electrode 25 to be kept constant. The components of the sample gas S introduced into the cell chamber 22 are thus detected as an electrical response which is a change in the frequency of the applied voltage.

Note that the method of detecting the sample S performed by the electrical signal conversion unit 30 may not be the above-described method of detecting a component as a change in the frequency of the applied pulse voltage; thus, the method is not limited to a particular method.

The control unit 40 includes a processor such as CPU to process data output from the electric signal conversion unit 30 and control the operation of the analytical device 1. The control unit 40 analyzes data output from the electric signal conversion unit 30, stores the data in a storage medium (not shown in the figure), and constructs a chromatogram from the data to display the chromatogram on the display unit 50 which includes a liquid crystal display monitor or the like.

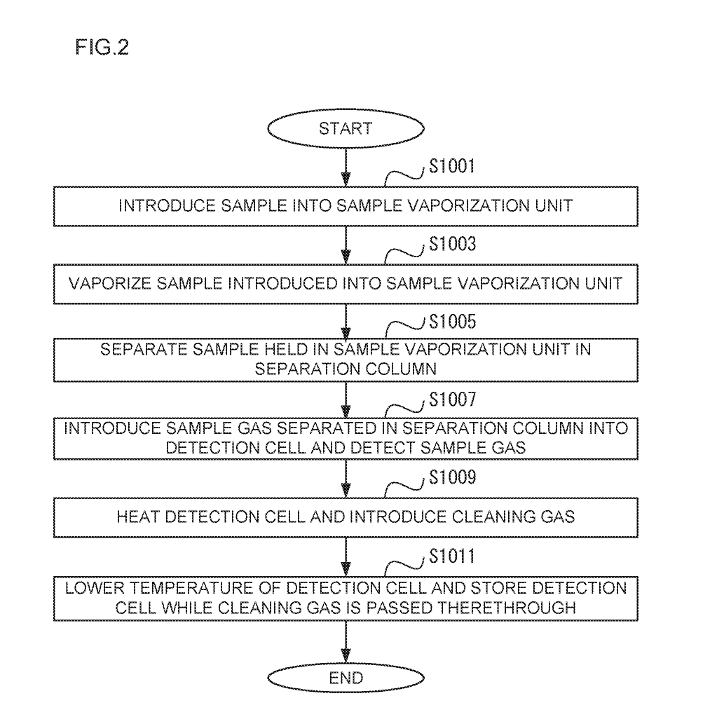

FIG. 2 is a flowchart showing a flow of a method of analyzing a sample. The method includes the method of cleaning a detection cell of an electron capture detector in the embodiment. In step S1001, the sample introduction unit 11 introduces the sample S into the sample vaporization unit 12. Upon completion of step S1001, step S1003 is started. In step S1003, the sample vaporization unit 12 vaporizes the sample S which have been introduced into the sample vaporization unit 12. Upon completion of step S1003, step S1005 is started.

Note that the sample S introduced into the sample vaporization unit 12 may be gas. In this case, step S1003 is omitted.

In step S1005, the separation column 14 separates the gas sample held in the sample vaporization unit 12. Each component of the sample S held in the sample vaporization unit 12 moves to the separation column 14, together with a carrier gas such as nitrogen that flows from the carrier gas introduction port 14 in a flow-controlled manner. The temperature of the separation column 14 is controlled by a thermostatic bath (not shown in the figure), and the components of the introduced sample S are separated at an appropriately set temperature. Upon completion of step S1005, step S1007 is started.

In step S1007, the electric signal conversion unit 30 introduces the sample gas S, which has been separated by the separation column 14, into the detection cell 20a and detects the sample gas S. The components of the sample gas S separated by the separation column 14, together with the carrier gas, are introduced into the cell chamber 22 through the sample gas introduction port 21 of the detection cell 20a of the electron capture detector 100a. As described above, among the components of the sample gas S, components having a high electron affinity are detected as a change in an electrical response of a circuit including the collector electrode 25. The control unit 40 performs data processing such as creating a chromatogram from the data based on the electrical response and displays the chromatogram on the display unit 50 as appropriate. Upon completion of step S1007, step S1009 is started.

In step S1009, the detection cell 20a is heated by the use of a heater or the like (not shown in the figure) and a cleaning gas is introduced into the detection cell 20a. The heating can reduce noise due to contamination caused by the sample. An excessively high temperature of the detection cell 20a leads to disadvantages such as an adverse effect on the detection cell 20a and taking a long time for heating. Therefore, the detection cell 20a is heated to 500° C. or less and preferably 300° C. or less. A cleaning gas is introduced into the heated detection cell 20a. The switching unit 230 then enters a second state, in which the switching unit 230 does not allow the makeup gas to flow into the detection cell 20a while it allows the cleaning gas to flow into the detection cell 20a. The cleaning gas introduced into the detection cell 20a exerts its reducing action to reduce oxidation on the inner wall of the cell chamber 22 and other places, which can result in a reduction of noise in the electron capture detector 100a. Upon completion of step S1009, step S1011 is started.

Note that heating may not be required when the cleaning gas is introduced into the detection cell 20a, and the temperature at which the cleaning gas is introduced into the detection cell 20a is not limited to a particular temperature.

In step S1011, the temperature of the detection cell 20a is lowered to a temperature that is set during storage, such as room temperature, and the detection cell 20a is stored while the cleaning gas is passed therethrough. Upon completion of step S1011, the process ends.

Note that the detection cell 20a may be stored with the cleaning gas held in the cell chamber 22. Alternatively, the detection cell 20a may be stored without the cleaning gas passed through or held in the cell chamber 22.

According to the embodiment described above, the following operational effects can be obtained.

(1) The method of cleaning a detection cell of an electron capture detector in the embodiment comprises introducing a cleaning gas into the detection cell 20a of the electron capture detector 100a, the detection cell 20a comprising a radiation source 24 that emits radiation, a sample gas introduction port 21 through which a sample gas S is introduced, and a collector electrode 25. This can reduce noise in the electron capture detector 100a caused by the detection cell 20a.

(2) In the method of cleaning a detection cell of an electron capture detector in the embodiment, the cleaning gas is a gas having a reducing property. This can reduce oxidation of the cell chamber 22 of the detection cell 20a, which can result in a reduction of noise in the electron capture detector 100a.

(3) In the method of cleaning a detection cell of an electron capture detector in the embodiment, the cleaning gas is hydrogen. This can use a highly reducing action of hydrogen to reduce oxidation of the cell chamber 22 of the detection cell 20a, which can result in an effective removal of noise.

(4) In the method of cleaning a detection cell of an electron capture detector in the embodiment, the cleaning gas is introduced into the detection cell 20a that is heated to a temperature of 500° C. or less. Thereby, both noise caused by contamination by the sample in the cell chamber 22 and noise caused by oxidation of the cell chamber 22 can be efficiently removed.

(5) The method of cleaning a detection cell of an electron capture detector in the embodiment prevents oxidation of the detection cell 20a by holding the cleaning gas in the detection cell 20a or continuously introducing the cleaning gas into the detection cell 20a. This can reduce noise generation due to oxidation of the detection cell 20a when the measurement is not performed.

(6) An analysis method in the embodiment comprises performing a measurement of a change in an electrical response of a circuit comprising the collector electrode 25, the change being caused by introducing the sample gas S through the sample gas introduction port 21 and introducing the makeup gas through the switching introduction port 23 so that components of the sample S receive electrons generated by the beta ray; and, when the measurement is not performed, cleaning the detection cell 20a by the method of cleaning a detection cell of an electron capture detector as described above. This enables the analysis to be performed with high accuracy with a reduced noise in the detection cell 20a.

(7) The detection cell 20a in the embodiment comprises a radiation source 24 that radiates beta rays, a sample gas introduction port 21 through which a sample gas S is introduced, a collector electrode 25 and a switching introduction port 23 through which a cleaning gas is introduced. This can reduce noise in the electron capture detector 100a caused by the detection cell 20a.

(8) The detection cell 20a in the embodiment comprises the switching unit 230 that switches between the makeup gas and the cleaning gas to introduce them through the switching introduction port 23. This eliminates the need for individual introduction ports for the makeup gas and the cleaning gas, reducing the complexity of piping around the detection cell 20a and noise in the electron capture detector 100a can be reduced.

(9) Since the electron capture detector 100a or the analytical device 1 in the embodiment comprises the detection cell described above, noise in the electron capture detector 100a caused by the detection cell 20a can be reduced.

(10) The detection cell 20a, the electron capture detector 100a, or the analytical device 1 in the embodiment comprises a gas leak sensor for detecting leakage of the cleaning gas. This can sense leakage of the cleaning gas to prevent accidents in a case where the cleaning gas is hydrogen or a gas having a high flammability.

The following variation is also contemplated within the scope of the present invention, and the variation may be combined with the above embodiment. In the following variation, parts having the same structures and functions as those of the above embodiment are denoted by the same reference numerals, and description thereof will be omitted as appropriate.

### Variation

In the above embodiment, switching between the makeup gas and the cleaning gas is performed by the switching unit 230 to introduce them into the detection cell 200a; however, introduction ports through which the makeup gas and the cleaning gas are individually introduced into the detection cell 20a may be provided.

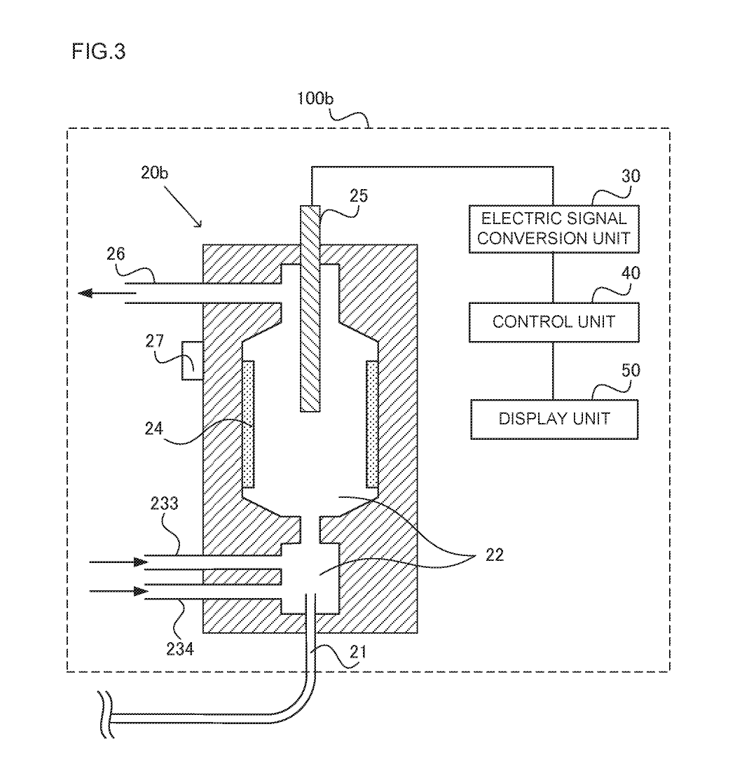

FIG. 3 is a view showing an electron capture detector 100b according to a variation of the above embodiment. A detection cell 20b of the electron capture detector 100b includes a makeup gas introduction port 233 through which a makeup gas is introduced into the cell chamber 22 and a cleaning gas introduction port through which the cleaning gas is introduced into the cell chamber 22, wherein the makeup gas introduction port 233 is a different port from and the cleaning gas introduction port 234. This eliminates the need for a mechanism of switching between the gases to be introduced into the detection cell 20b, while noise can be reduced in the electron capture detector 100a.

The embodiment of the present invention described above eliminates the need for replacement of the detection cell and can reduce noise in the electron capture detector due to oxidation of the detection cell or other reasons.

The present invention is not limited to the above embodiment. Other aspects contemplated within the technical idea of the present invention are also included within the scope of the present invention.

### EXAMPLE

The following example describes results of measurements of a chromatogram before and after performing the method of cleaning a detection cell of an electron capture detector described above for a gas chromatograph including an electron capture detector. It should be understood that the present invention is not limited to conditions described in the following Example.

Conditions of Gas Chromatography

### Sample Vaporization Chamber:

carrier gas: helium, vaporization chamber temperature: 120.0° C., control mode: pressure mode, pressure: 170.3 kPa, total flow rate: 65.2 mL/min, column flow rate: 2.96 mL/min, linear velocity: 37.8 cm/sec, purge flow rate: 3.0 mL/min, split ratio: 20.0 Separation column:

Rxi-624Sil MS (Shimadzu GLC), length: 60.0 m, inner diameter: 0.32 mm ID, liquid phase film thickness: 1.80 μm, column temperature: 80.0° C. equilibration time: 3.0 min

### Column Temperature Program: (Total Time 11.00 Minutes)

| rate (° C./min) | Temperature (° C.) | Hold time (min) |
|---|---|---|
| — | 80.0 | 0.00 |
| 10.0 | 120.0 | 7.00 |

Conditions of Electron Capture Detector

detector temperature: 130.0° C., sampling rate: 40 msec, end time: 11.00 min, delay time: 0.00 min, differential signal detector: none, current: 0.10 nA, makeup gas: nitrogen

Conditions for Cleaning

electron capture detector temperature: 300° C., hydrogen introduction rate: 30 mL/min. cleaning time: 18 hours

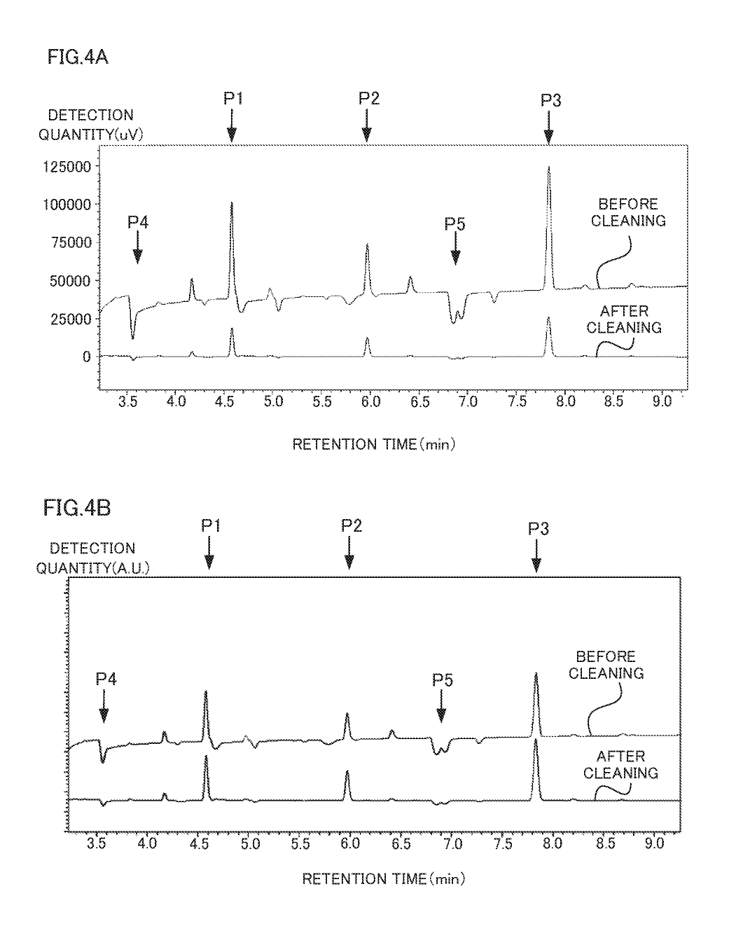

FIG. 4A shows chromatograms before and after cleaning obtained in the Example. Peaks P1, P2, and P3 indicate peaks of known components contained in a measured sample, and peaks P4 and P5 are peaks caused by noise. FIG. 4B shows chromatograms before and after cleaning, normalized so that an area of the peak P3 is the same in the chromatograms before and after cleaning. In the chromatogram after cleaning, peaks caused by noise decrease so that the S/N ratio increases.

What is claimed is:

1. A method of cleaning a detection cell of an electron capture detector, the detection cell comprising a radiation source that emits radiation, a sample gas introduction port through which a sample gas is introduced, and a collector electrode, the method comprising:
introducing a cleaning gas into the detection cell of the electron capture detector.

2. The method of cleaning a detection cell of an electron capture detector according to claim 1, wherein:
the cleaning gas is a gas having a reducing property.

3. The method of cleaning a detection cell of an electron capture detector according to claim 2, wherein:
the cleaning gas is hydrogen.

4. The method of cleaning a detection cell of an electron capture detector according to claim 1, wherein:
the cleaning gas is introduced into the detection cell that is heated to a temperature of 500° C. or less.

5. The method of cleaning a detection cell of an electron capture detector according to claim 2, wherein:
the cleaning gas is introduced into the detection cell that is heated to a temperature of 500° C. or less.

6. The method of cleaning a detection cell of an electron capture detector according to claim 3, wherein:
the cleaning gas is introduced into the detection cell that is heated to a temperature of 500° C. or less.

7. The method of cleaning a detection cell of an electron capture detector according to claim 1, wherein:
oxidation of the detection cell is prevented by holding the cleaning gas in the detection cell or continuously introducing the cleaning gas into the detection cell.

8. The method of cleaning a detection cell of an electron capture detector according to claim 2, wherein:
oxidation of the detection cell is prevented by holding the cleaning gas in the detection cell or continuously introducing the cleaning gas into the detection cell.

9. The method of cleaning a detection cell of an electron capture detector according to claim 3, wherein:
oxidation of the detection cell is prevented by holding the cleaning gas in the detection cell or continuously introducing the cleaning gas into the detection cell.

10. The method of cleaning a detection cell of an electron capture detector according to claim 4, wherein:
oxidation of the detection cell is prevented by holding the cleaning gas in the detection cell or continuously introducing the cleaning gas into the detection cell.

11. The method of cleaning a detection cell of an electron capture detector according to claim 5, wherein:
oxidation of the detection cell is prevented by holding the cleaning gas in the detection cell or continuously introducing the cleaning gas into the detection cell.

12. The method of cleaning a detection cell of an electron capture detector according to claim 6, wherein:
oxidation of the detection cell is prevented by holding the cleaning gas in the detection cell or continuously introducing the cleaning gas into the detection cell.

13. An analysis method of analyzing a sample with an analytical device comprising an electron capture detector, the electron capture detector comprising a detection cell comprising a radiation source that emits radiation, a sample gas introduction port through which a sample gas is introduced, a makeup gas introduction port through which a makeup gas is introduced, and a collector electrode, the method comprising:
performing a measurement of a change in an electrical response of a circuit comprising the collector electrode, the change being caused by introducing the sample gas through the sample gas introduction port and introducing the makeup gas through the makeup gas introduction port so that components of the sample receive electrons generated by the radiation; and
when the measurement is not performed, cleaning the detection cell by the method of cleaning a detection cell of an electron capture detector according to claim 1.

14. A detection cell of an electron capture detector, the detection cell comprising a radiation source that emits radiation, a sample gas introduction port through which a sample gas is introduced, a collector electrode, and a cleaning gas introduction port through which a cleaning gas is introduced.

15. The detection cell of an electron capture detector according to claim 14, further comprising:
a makeup gas introduction port through which a makeup gas is introduced, the makeup gas introduction port being different from the cleaning gas introduction port.

16. The detection cell of an electron capture detector according to claim 14, further comprising:
a switching mechanism for switching between a makeup gas and the cleaning gas to be introduced through the cleaning gas introduction port.

17. An electron capture detector comprising the detection cell of an electron capture detector according to claim 14.

18. The electron capture detector according to claim 17, further comprising:
a leakage detection sensor that detects leakage of the cleaning gas.

19. An analytical device comprising the electron capture detector according to claim 17.
